(19) United States
(12) Patent Application Publication
(10) Pub. No.: US 2004/0201689 A1
(43) Pub. Date: Oct. 14, 2004

(54) Method and system for recording a history of an image file history

(76) Inventors: Angelica Quintana, Fort Collins, CO (US); Ted Ziemkowski, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/104,498

(22) Filed: Mar. 21, 2002

(51) Int. Cl. H04N 5/225; H04N 9/04

(52) U.S. Cl. 348/207.1

(57) ABSTRACT

A log of events that occur to an image file is kept. For example, if the image is e-mailed, printed, edited, etc., the event is recorded in the log. Consequently, a user can review the log and know what has been done with the image file previously. This log is created and maintained automatically. The log may be created when the image file is downloaded to a computer from a digital camera along with a specific instruction or intent of what is to be done immediately with the image file by the computer, e.g., e-mail or print the file. The log may also be created or updated subsequently as the image file is used. The log may be written into the image file or may be written in a separate file that is stored with the image file.

### FIELD OF THE INVENTION

The present invention relates to the field of digital imaging and electronic image files that can be transmitted between, for example, a digital camera and a computer or computer network. More specifically, the present invention provides a means of recording, with the image file, a history including, for example, any actions taken with the file when the file was downloaded from a digital camera and/or any subsequent use or manipulation of the file.

### BACKGROUND OF THE INVENTION

Digital imaging has a wide variety of applications in both the personal and professional worlds. For example, people on a vacation are able to take digital pictures with a digital camera and then transmit the resulting image files to friends and family at home. Image files can be transferred, for example, on a floppy disk or over the Internet. Similarly, friends and family members living far from each other can share digital pictures of people and events almost instantaneously.

The applications for professionals and businesses are equally exciting. Business partners or company employees separated by large distances can trade images of, for example, new personnel, products under development, product samples for potential purchase, etc.

Typically, after a digital image is created, the file for the image is downloaded from the digital camera where it was generated to a computer or computer network. This is done to provide for long-term storage of the image file and to allow the user to make wide and varied uses of the image file that will be mentioned below.

The image file can be transferred from camera to computer, for example, by recording the image file on a floppy or optical disc using a disc drive built into the camera. The disc bearing the file is then transferred to the computer. Alternatively, the camera may transmit the image file directly to the computer. This is typically done by connecting a data link, for example, a Universal Serial Bus (USB) or other cable connection, between the camera and the computer.

Once the file has been transferred to a computer, it can be transmitted over the Internet, assuming the computer has an Internet connection. Additionally, if the computer is connected to a printer, the image may also be printed by the printer in hardcopy form. The hardcopy can be displayed, stored or shared as desired by the user.

Additionally, computer programs exist that allow a user to edit a digital image file. For example, the image can be rotated to a different orientation, the colors or tint of the image can be changed, the image can be cropped or resized, and even the content of the image itself can be manipulated.

While digital imaging allows almost unlimited flexibility in creating, sharing and editing images, the flexibility of current systems can also cause some problems. For example, a user may be unable to remember if a particular image has already been sent to a particular friend, relative or business associate. Additionally, a user may want to know if an image has been printed in hardcopy form or if copies of the image file have been made. Looking at a particular image file, there has been no way to determine if that file has been e-mailed, printed, copied, etc.

Additionally, for some applications, it may be necessary or desirable to know if any editing has been performed on the image. For example, before an electronic image can be used and relied upon by law enforcement or an insurance company, the integrity of the image, i.e., the fact that the image has not been edited or altered, must be established. Similarly, a historian or investigator may wish to know precisely what, if any, changes have been made to a digital image.

Consequently, there is a need in the art for a means and method of tracking the history of events that occur to an electronic image file.

### SUMMARY OF THE INVENTION

The present invention provides, among other things, a method of recording a history of an image file, said method comprising writing a description of each of a series of uses made of said image file to an electronic event log associated with said image file.

In another embodiment, the present invention may be a system for recording a history of an image file. Such a system may include at least one application which is configured to run on a computer or processor and to access an image file, and an electronic event log associated with said image file, where the application is configured to record an entry in the event log when the image file is used by the application, this entry describing what use the application made of the image file.

In another embodiment, the present invention may be computer readable instructions stored on a medium for storing computer readable instructions, where the instructions cause a computer or processor to monitor use of an electronic image file by one or more applications; and automatically write a description of a use made of the image file to an electronic event log associated with said image file.

### BRIEF DESCRIPTION OF THE DRAWINGS

The accompanying drawings illustrate embodiments of the present invention and are a part of the specification. Together with the following description, the drawings demonstrate and explain the principles of the present invention. The illustrated embodiment are examples of the present invention and do not limit the scope of the invention.

FIG. 1 is an illustration of a digital camera transferring image files to a computer for purposes of explaining the present invention.

FIG. 2 is an illustration of a first embodiment of the present invention in which an intent log is created when an image file is transferred to a computer from a digital camera.

FIG. 2a is an illustration of a second embodiment of the present invention in which the intent log is updated by firmware in a printer.

FIG. 2b is an illustration of a third embodiment of the present invention in which the intent log is updated by firmware or software in a PDA.

FIG. 3 is an illustration of a fourth embodiment of the present invention in which an intent log is created when an image file is created or transferred to a computer from a digital camera.

FIG. 4 is a flow chart showing a method of the present invention as implemented by the systems in FIGS. 2 and 3.

FIG. 5 is an illustration of a fifth embodiment of the present invention in which an event log is created that tracks what happens to an image file.

FIG. 6 is an illustration of a sixth embodiment of the present invention in which an event log is created that tracks what happens to an image file.

FIG. 7 is a flow chart showing a method of the present invention as implemented by the systems in FIGS. 5 and 6.

FIG. 8 is an illustration of another aspect of the present invention in which the logs created for an image can be accessed through a file manager application using a function for displaying file properties.

Throughout the drawings, identical elements are designated by identical reference numbers.

### DETAILED DESCRIPTION OF THE INVENTION

The present invention provides a system for recording a log of events that occur to an image file, for example, if the image is e-mailed, printed, edited, etc. Consequently, a user can review the log and know what has been done with the image file previously. This log is preferably generated and maintained automatically. The log may be created when the image file is downloaded to a computer from a digital camera along with a specific instruction or intent of what is to be done immediately with the image file by the computer, e.g., e-mail or print the file. The log may also be created or updated subsequently as the image file is used. The log may be written into the image file or may be written in a separate file that is stored with the image file.

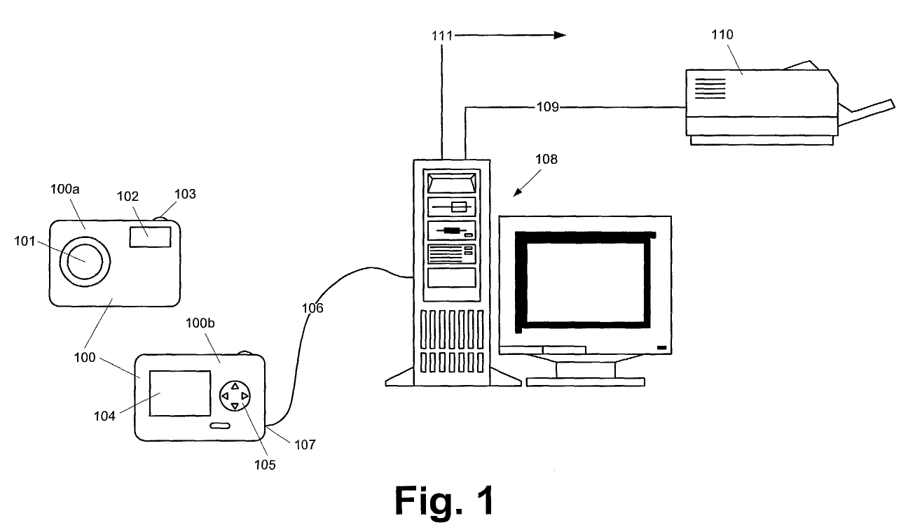

FIG. 1 is an illustration of a digital camera that is transferring image files to a computer and may be used for purposes of explaining the present invention. As shown in FIG. 1, a digital camera may be used to create digital image files. The digital camera (100) typically has a front face (100a) that includes a lens (101) and perhaps a flash (102). A button (103) is used to activate the electronics in the camera (100) that generate an electronic image of the scene viewed through the lens (101), i.e., to take a picture.

The rear face (100b) of the camera (100) usually includes a display (104), e.g., a liquid crystal display. The display (104) can show the user, for example, the scene currently viewed through the lens, an image taken by the camera, and/or a menu of commands for controlling the camera (100).

A user input device (105) is typically provided for controlling the majority of the functions of the camera (100). The user input device (105) may be, for example, a four-way button which can be actuated around its periphery in four, eight or more different directions to move a cursor or a highlight on the display (104) so as to navigate through command menus, files lists, etc. When the desired item is highlighted or indicated on the display (104), a selection can be made by pressing the center of the four-way button (105), or some other selection button.

While this describes a common example of a digital camera, there are many other forms of digital camera. For example, some digital video cameras can also function as a digital still camera and create digital image files. Some Personal Digital Assistants (PDAs) have attachments that include a lens and other components that allow the generation of digital image files. A digital camera can also consist of a lens connected to a personal computer. The lens provides imaging input, and the personal computer uses the input with an appropriate application to create a digital image.

In the present specification and particularly in the appended claims, the term “digital camera” shall refer to any device that generates an electronic image file. The present invention may be practiced with any form of digital camera.

Image files may also be generated in a wide variety of formats. For example, common image file formats include Tagged Image File Format (TIFF), Bitmap (BMP), Graphics Interchange Format (GIF), Joint Pictures Expert Group format (JPG), Portable Document Format (PDF) and PostScript format. The present invention is not restricted to any particular image file format and can be practiced with any image file format.

A digital camera (100) that is a separate unit from a personal computer (108) may transmit or download image files to the computer (108). The image file can be transferred from camera to computer, for example, by recording the image file on a floppy or optical disc using a disc drive built into the camera. The disc bearing the file is then transferred to the computer.

Alternatively, as shown in FIG. 1, the transfer is performed by connected a wired data link (106) between the camera (100) and the computer (108). The connection (106) may be, for example, a Universal Serial Bus, an IEEE 1394 connection or other standard or custom connection. Within the principles of the present invention, the digital camera (100) may also transmit image files to the computer (108) wirelessly with, for example, an infrared or radio frequency transmitter.

However the image file is transferred from the digital camera (100) to the computer (108), it may also be transferred with an initial instruction, known as an “intent” or an “intent instruction,” that specifies an action to be immediately taken upon the downloading of the file to the computer (108). The intent instruction can be entered into the camera (100) in connection with a particular image file using, for example, the user input device (105). The intent instruction is then transmitted with the file to the computer (108) and executed by the computer (108).

For example, an intent instruction may be to e-mail the image file to a specified recipient. The computer (108), having a connection (111) to the Internet and an e-mail application resident thereon, executes this intent instruction by automatically e-mailing the received image file to the designated recipient. Alternatively, the intent instruction may be to print the image file. The computer (108), having a connection (109) to a printer (110) and a printer driver resident thereon, executes this intent instruction by automatically formatting and sending the image file to the printer (110) where the image is printed in hardcopy form. An intent instruction may be a single instruction or a series of instructions specifying actions to be taken with the incoming image file.

In prior devices, after an intent instruction is received and executed, no record of what was done with the file is made. Consequently, there is no way subsequently to know if the image file was printed, e-mailed or had some other use made of it when it was downloaded to the computer (108). The present invention addresses the problems that this can create.

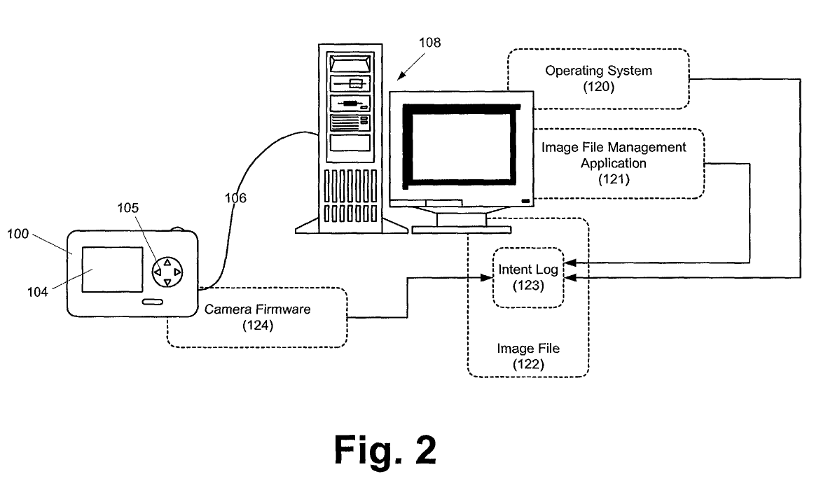

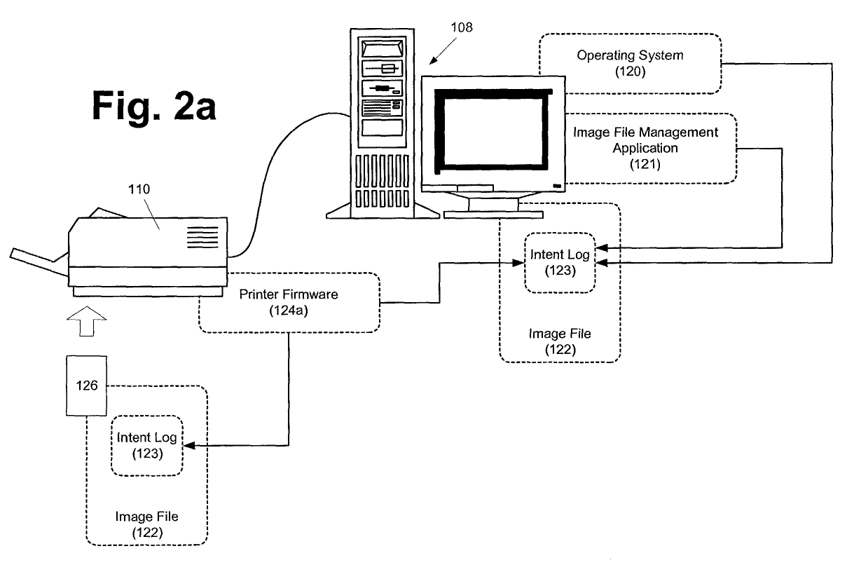

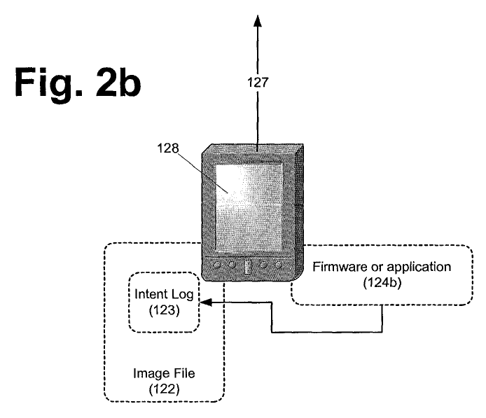

FIG. 2 is an illustration of a first embodiment of the present invention in which an intent log is created when an image file is transferred to a computer from a digital camera with an intent instruction. As shown in FIG. 2, the digital camera (100) downloads the image file (122) to the computer (108) or to a computer network. The image file (122) is downloaded with an intent instruction. The computer (108) will execute the intent instruction upon receiving the download of the file (122) as described above.

However, the intent instruction or an indication of what the intent instruction was is then written to an intent log (123). In the present embodiment, the intent log (123) is part of the image file (122). In other words, the intent log (123) may be part of the metadata stored in the image file (122).

The intent log (123) may be written into the image file (122) by any of a number of different systems. Many self-contained electronic devices, for example, a digital camera (100), include firmware, i.e., computer programming or instructions that reside in the device and are executed by a processor in the device. Consequently, the firmware (124) in the digital camera (100) may write the intent log (123) into the file (122). This would preferably be done just before the file (122) and intent instruction are downloaded to the computer (108). Alternatively, an image file management application (121) running on the computer (108) may receive the image file and store in on the computer (108), e.g., on a hard drive. The image file management application (121) may also write the intent log (123) to the image file (122) as the image file (122) is saved to the computer (108). In still another alternative, the operating system (120) running on the computer (108) may write the intent log (123) to the image file (122).

Other applications running on the computer (108) may be responsible for writing the intent log (123) to the image file (122). Under the principles of the present invention, it is less important what means are used to generate the intent log (123) as it is that the log (123) is created and provides a history of the image file and any applicable intent instructions.

With the intent log (123) written into the image file (122), a user can then access the intent log (123) to learn what intent instruction accompanied the file (122) when it was downloaded to the computer (108). Consequently, the user will also then know what was done with the file (122) per the intent instruction. Access of the intent log (123) can be through a file management application or other means as will be discussed in further detail below.

FIG. 2a illustrates a second embodiment of the present invention in which an image file (122) is downloaded with an intent instruction that directs that the image file be printed. If the image file (122) is downloaded with such an intent instruction to a computer (108), the computer (108) will send the file to a printer (110) for printing. The computer (108) may then record the printing of the file in the intent log (123). Alternatively, the printer (110) that prints the image file may have firmware (124a) that records the printing in the intent log (123).

Additionally, the image file (122) may be transferred directly to the printer (110) rather than through a computer (108). For example, a flash memory card (126) may be used by the digital camera or other imaging device to record and store the image file (122). Some printers (e.g. 110) can receive such a memory card (126) and read the image file (122) directly therefrom. The printer (110) can then print the file (122) based on the intent instruction without any intervention by the host computer (108). The printer firmware (124a) can then record the printing of the image file (122) in the intent log (123).

FIG. 2b illustrates a second embodiment of the present invention in which an image file (122) is created using a PDA (128) that has the necessary additional hardware to function as a digital camera, as discussed above. In this case, the image file (122) is created using the PDA (128). Moreover, the image file (122) is associated with an intent instruction to e-mail the image file (122) to a designated recipient.

In the example of FIG. 2b, the PDA (128) has a connection (127) to the Internet. This connection (127) may be through a host computer to which the PDA (128) is periodically connected and with which the PDA (128) is periodically synchronized. Alternatively, the PDA (128) may have wireless communications hardware and the connection (127) may be a wireless communication link to a wireless infrastructure that supports the PDA (128).

In either case, the PDA (128) can execute the intent instruction to e-mail the image file (122) to a designated recipient using the connection (127) to the Internet. The firmware or software application (124b) on the PDA (128) then writes a record of the e-mailing of the file (122) to the intent log (123).

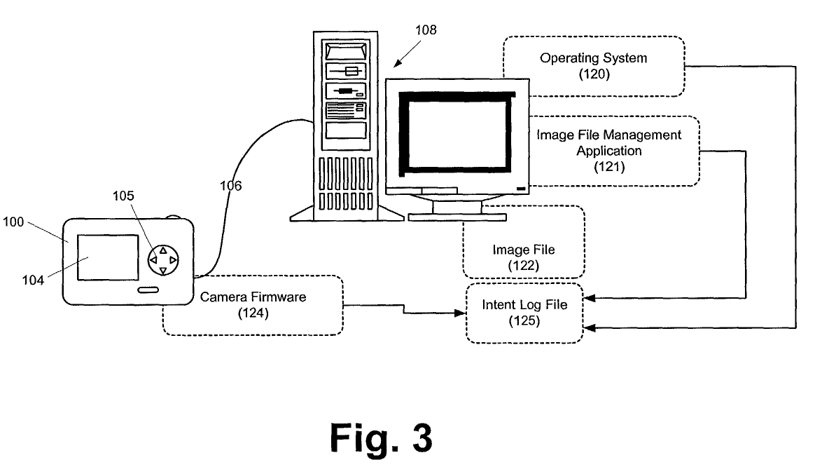

FIG. 3 is an illustration of a fourth embodiment of the present invention in which an intent log is created when an image file is created or transferred to a computer from a digital camera. As shown in FIG. 3, the intent log need not be written into the image file (122). Rather, a separate file, an intent log file (125) can be created in which the intent instruction is recorded or described.

As before, the intent log file (125) can be created by the camera firmware (124), printer firmware (124a), PDA firmware or software (124b), other device firmware, the image file management application (121), the operating system (120) or some other application. The intent log file (125) may be a text file that can be accessed using any word processing or text editing application. In this way, the intent instruction that accompanied the file (122) can be reviewed so long as the intent log file (125) is available.

The intent log file (125) is preferably associated in some manner with the image file (122) to facilitate the location of the intent log file (125) when desired. For example, the intent log file (125) is preferably stored in the same file directory on the computer (108) as the image file (122). Alternatively or additionally, the intent log file (125) may be created with the same name as the image file (122) with some additional indication that it is the corresponding log file. For example, the image file (122) and log file (125) may have the same name, but different extensions following the name. For example, the image file (122) may be named “image.jpg,” while the log file (125) may be named “image.log.” Alternatively, the file names could be “image.jpg” for the image file (122) and “image-log.txt” or “image-log.doc” for the log file (125).

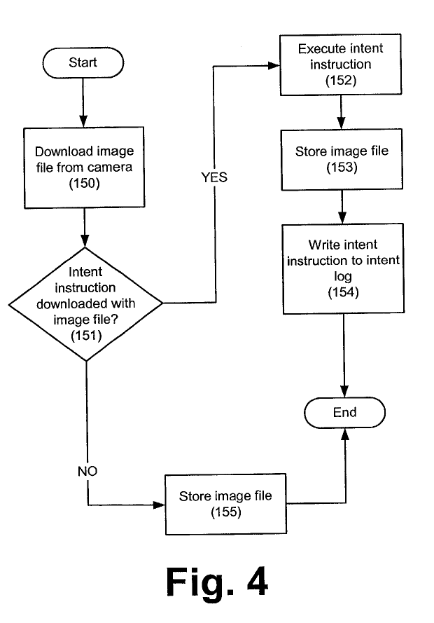

FIG. 4 is a flow chart showing a method of the present invention as implemented by the systems in FIGS. 2 and 3. As shown in FIG. 4, the method begins when an image file (150) is downloaded or transferred from a digital camera to a computer or computer network.

The image file may or may not be accompanied by one or more intent instructions (151). If no intent instructions are provided, the image file is stored on the computer (155) and the method of the present invention is completed. However, if one or more intent instructions are provided, those instructions are executed (152). As noted above, this may entail, for example, e-mailing the image file or printing a hard copy of the image file.

The image file is then stored to the long-term, non-volatile memory of the receiving computer system (153). The intent instruction or instructions are written to an intent log (154). This log may be metadata within the image file or may be a separate log file as described above.

It will be appreciated that the precise order of the steps of this method may be rearranged within the principles of the present invention. For example, the image file could be stored before the intent instructions are executed. The intent log could be written contemporaneously with the storing of the image file on, for example, the computer's hard drive.

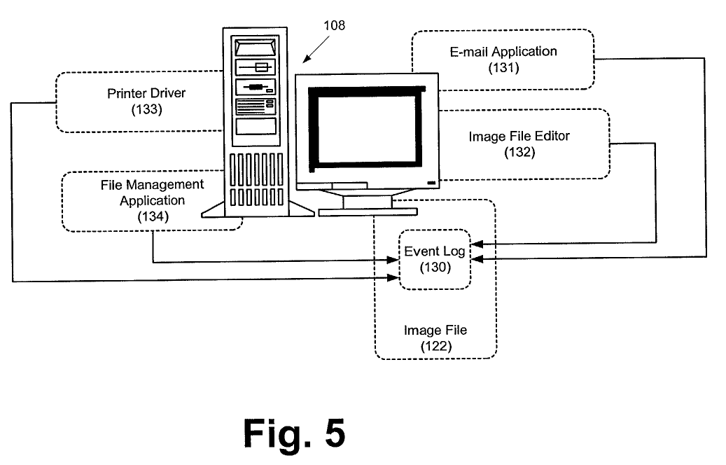

FIG. 5 is an illustration of a fifth embodiment of the present invention in which an event log is created that tracks what happens to an image file. In addition to the intent log described above, it may be desirable to know the history of an image file from the time it was downloaded, with or without intent instructions, to the present. Consequently, as shown in FIG. 5, an event log (130) can be created. The event log (130) may include the intent log and a listing or description of intent instruction as described above. However, the event log (130) will also contain a listing or description of the use made or actions taken with the image file (122) throughout its history.

Applications on the computer (108) that access, use or modify the image file (122) can record the action taken in the event log (130). For example, if the image file (122) is printed, it will be formatted and sent to a printer using a printer driver (133) running on the computer (108). The printer driver (133) can then write an entry to the event log (130) indicating that the image was printed. This entry may include the date and time the file was printed, the number of copies made and any other information about the print job.

Additionally, if the image file (122) is e-mailed to a designated recipient, an e-mail application (131) will be used to create and send the e-mail message. The e-mail application (131) can then write an entry to the event log (130) indicating that the image file (122) was e-mailed. This log entry may include such information as the date and time the file was e-mailed, the intended recipient, etc.

The image file (122) may also be manipulated using a file management application (134). The file management application (132) maybe used, for example, to copy, move or rename the image file (122). The file manager (134) can then write an entry to the event log (130) listing or describing the action taken. For example, this entry may include the old and new names of a renamed file and date the file was renamed, the previous location of a moved file and the date it was moved, the number of times the file has been copied and when, etc.

Finally, the image file (122) maybe edited using an image file editor (132). As described above, the image file editor (132) can be used to effect any number of changes to the image file. For example, the image can be rotated or cropped, the colors and tint can be adjusted, and the content of the image or shapes within the image can be changed. The image editor (132) can then write an entry to the event log (130) indicating that the image has been edited. Preferably, this entry to the event log (130) will specify what edits were made, e.g., the image was cropped, an object was removed from the image, the color or tint of the image or objects in the image were changed.

This last feature can be of great value in law enforcement or insurance applications. For such purposes, the integrity of an image, i.e., the fact that an image is accurate and has not been edited or altered, must be established before the image can be used as evidence in a legal matter or in support of an insurance claim. An event log (130) that indicates the image file (122) has not been edited supports use of the image as evidence in a legal matter or support for an insurance claim.

In the foregoing description, the various applications that use the image file (122) write entries to the event log (130) directly. Preferably, the event log (130) adheres to some standard that can then be used by the application interfaces of the various applications (e.g., 131-134) to write to the standardized event log (130).

Alternatively, there may be a particular application, a specific log keeping application or, perhaps, a file management application (134), that receives the data for log entries from the other applications (e.g., 131-134) and then writes appropriate entries to the event log (130).

As shown in FIG. 5, the event log (130) can be written into the image file (130). In such as case, the event log (130) may be part of the metadata stored in the image file (122).

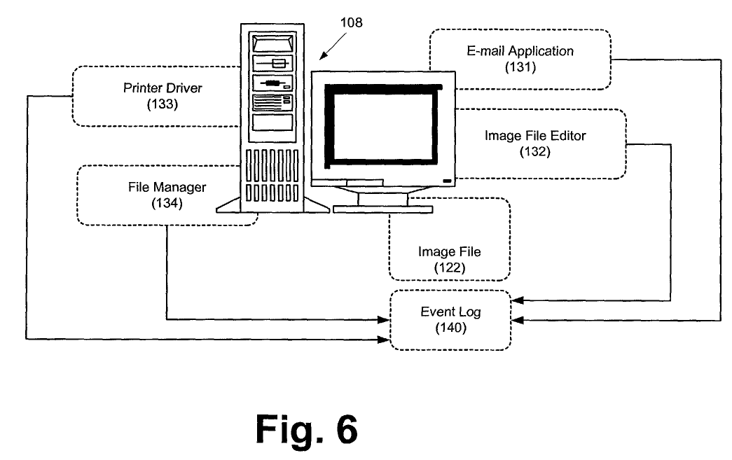

FIG. 6 is an illustration of a sixth embodiment of the present invention. The embodiment of FIG. 6 is substantially similar to that of FIG. 5. However, FIG. 6 illustrates that the event log (140), like the previously described intent log (125), can be a separate file (140) rather than a part of the image file (122).

As before, the event log file (130) is preferably associated in some manner with the image file (122) to facilitate the location of the event log file (130) when desired. For example, the event log file (130) is preferably stored in the same file directory on the computer (108) as the image file (122). The event log file (130) also maybe created with the same name as the image file (122) with some additional indication that it is the corresponding log file. For example, the image file (122) and log file (125) may have the same name, but different extensions following the name. For example, the image file (122) may be named “image.jpg” while the log file (130) may be named “image.log.” Alternatively, the file names could be “image.jpg” for the image file (122) and “image-log.txt” or “image-log.doc” for the log file (130).

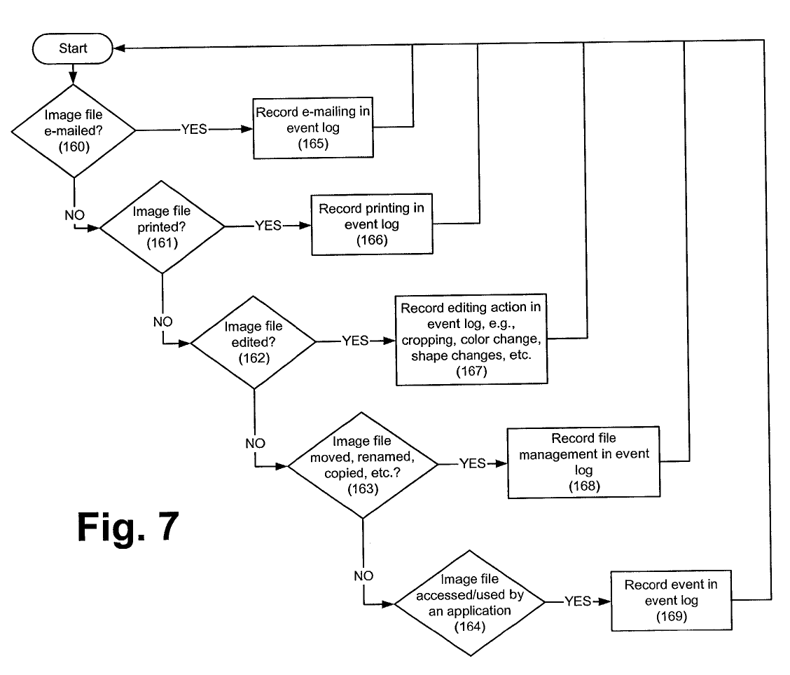

FIG. 7 is a flow chart showing a method of the present invention as implemented by the systems in FIGS. 5 and 6. As shown in FIG. 7, when any of a variety of actions are taken with the image file, a listing or description of the event is recorded in the event log.

If the image file is e-mailed (160), the e-mail transmission of the file is recorded in the event log (165). This log entry may include, for example, the date and time the file was sent and the designated recipient to whom the file was sent.

If the image file is printed (161), the printing of the file is recorded in the event log (166). This log entry may include, for example, the date and time the file was printed, the printer used and/or any special print instructions, such as resolution setting, color or grayscale, paper size, etc.

If the image file is edited (162), the edits made are recorded in the event log (167). This log entry will preferable indicate not just that the image was edited, but indicate what type of edits were made, for example, the image was cropped, an object was removed from the image, the color or tint of the image or objects in the image were changed, what user edited the file etc.

If the image file is otherwise accessed, for example, if the image file is moved, renamed, copied, etc., (163), the file management event is recorded in the event log (168). This log entry may include the old and new names of renamed file and date the file was renamed, the previous location of a moved file and the date it was moved, the number of times the file has been copied and when.

Finally, there are other applications that may make some use of an image file and future applications may be developed which make some use of an image file. If an image file is accessed or used by any application (164), a log entry describing the event can be recorded in the event log (169).

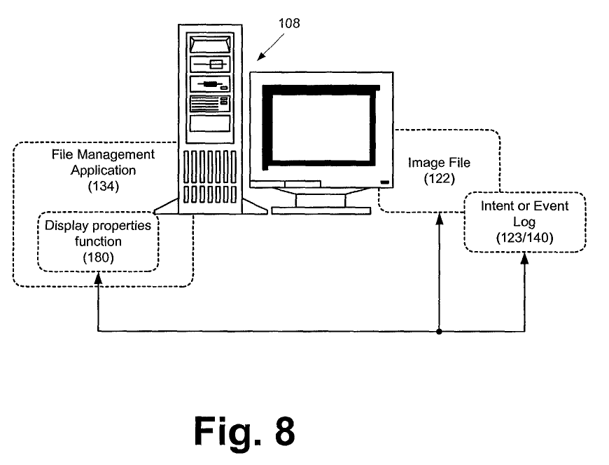

FIG. 8 is an illustration of another aspect of the present invention in which the logs created for an image can be accessed through a file manager application using a function for displaying file properties. As shown in FIG. 8, a computer (108) on which an image file (122) is resident, preferably also has a file management application (134) running thereon. The file manager (134) can be used to move through hierarchical directories of files and applications stored on the computer (108), including image files. The file manager (134) can also be used to copy, move, delete, rename or otherwise manage the files on the computer (108).

Additionally, a file manager (134) of the present invention preferably includes a display properties function (180) that makes use of the information in the intent or event log (123/140) that is in, or associated with, an image file (122). The user may use the file manager (134) to locate and select a particular image file. The user may then direct the file manger (134) to display the properties of the image file (122).

Under the principles of the present invention, the display properties function (180) then accesses the intent log (123) or the event log (140) that is associated with the selected image file (122). As described above, the intent log (123) or event log (140) may be stored in the image file (122) or in a separate, associated file. The file manager (134) then displays the contents of the log (123/140) for the user so that the user can learn what intent instructions the image file (122) was originally downloaded with and/or what uses have been made of the image file (122) subsequent to the creation of the log (123/140).

The preceding description has been presented only to illustrate and describe the invention. It is not intended to be exhaustive or to limit the invention to any precise form disclosed. Many modifications and variations are possible in light of the above teaching.

The embodiments described above was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of recording a history of an image file, said method comprising writing a description of each of a series of uses made of said image file to an electronic event log associated with said image file.

2. The method of claim 1, wherein said writing a description of uses made of said image file further comprises:
downloading said image file from a digital camera to a computer with an intent instruction; and
recording a description of said intent instruction in said event log as a use made of said image file.

3. The method of claim 2, wherein said recording of said description of said intent instruction is performed by firmware in said digital camera.

4. The method of claim 2, further comprising printing said image file with a printer, wherein said recording said description of said intent instruction is performed by firmware in said printer.

5. The method of claim 1, further comprising:
creating said image file with a personal digital assistant;
entering an intent instruction to e-mail said image file to a designated recipient; and
recording a description of said intent instruction in said event log as a use made of said image file, wherein said recording said description of said intent instruction is performed by said personal digital assistant.

6. The method of claim 1, wherein said image file comprises said event log and said writing said description to said event log comprises writing said description to said event log within said image file.

7. The method of claim 1, wherein said event log is stored in a log file separate from said image file and said writing said description to said event log comprises writing said description to said event log in said separate log file.

8. The method of claim 1, further comprising editing said image file, wherein said writing said description of uses made of said image file comprises writing a description of edits made to said image file in said event log.

9. The method of claim 1, farther comprising e-mailing said image file to a designated recipient, wherein said writing said description of uses made of said image file comprises recording said e-mailing of said image file in said event log.

10. The method of claim 1, farther comprising printing said image file, wherein said writing said description of uses made of said image file comprises recording said printing of said image file in said event log.

11. The method of claim 1, further comprising renaming, moving or copying said image file with a file management application, said writing said description of uses made of said image file comprises recording said use of said image file by said file management application in said event log.

12. The method of claim 1, further comprising:
selecting said image file using a file management application; and
reviewing contents of said event log with a display properties function of said file management application.

13. A system for recording a history of an image file, said system comprising:
at least one application which is configured to run on a computer or processor and to access an image file; and
an electronic event log associated with said image file,
wherein said application is configured to record an entry in said event log when said image file is used by said application, said entry describing what use said application made of said image file.

14. The system of claim 13, further comprising:
a digital camera;
a computer; and
a data transfer link between said digital camera and said computer;
wherein said digital camera transfers said image file to said computer with an intent instruction, a record of said intent instruction being recorded in said event log.

15. The system of claim 14, wherein said at least one application comprises firmware running on a processor of said digital camera.

16. The system of claim 12, wherein said at least one application comprises an operating system running on a computer.

17. The system of claim 12, wherein said at least one application comprises a file management application running on a computer.

18. The system of claim 12, said at least one application comprises a printer driver running on a computer.

19. The system of claim 12, said at least one application comprises an image editor running on a computer.

20. The system of claim 12, said at least one application comprises an e-mail application running on a computer.

21. The system of claim 12, wherein said electronic event log is incorporated in said image file.

22. Computer readable instructions stored on a medium for storing computer readable instructions, said instructions causing a computer or processor to:
monitor use of an electronic image file by one or more applications; and
automatically write a description of a use made of said image file to an electronic event log associated with said image file.

23. A system for recording a history of an image file, said system comprising:
means for writing a description of each of a series of uses made of said image file to an electronic event log; and
means for associating said event log with said image file.

24. The system of claim 23, wherein said means for writing a description of uses made of said image file further comprises:
means for downloading said image file from a digital camera to a computer with an intent instruction; and
means for recording a description of said intent instruction in said event log as a use made of said image file.

25. The system of claim 24, wherein said means for recording of said description of said intent instruction comprises firmware in said digital camera.

26. The system of claim 24, further comprising means for printing said image file, wherein said means for recording said description of said intent instruction is performed by said means for printing.

27. The system of claim 23, further comprising:
means for creating said image file on a personal digital assistant;
means for entering an intent instruction to e-mail said image file to a designated recipient; and
means for recording a description of said intent instruction in said event log as a use made of said image file, wherein said recording said description of said intent instruction is performed by said personal digital assistant.

28. The system of claim 23, wherein said means for a associating said event log with said image file comprises means for incorporating said event log into said image file and said means for writing said description to said event log comprises means for writing said description to said event log within said image file.

29. The system of claim 23, wherein said event log is stored in a log file separate from said image file and said means for writing said description to said event log comprises writing said description to said event log in said separate log file.

30. The system of claim 23, further comprising means for editing said image file, wherein said means for writing said description of uses made of said image file comprises means for writing a description of edits made to said image file in said event log.

31. The system of claim 23, further comprising means for e-mailing said image file to a designated recipient, wherein said means for writing said description of uses made of said image file comprises means for recording said e-mailing of said image file in said event log.

32. The system of claim 23, further comprising means for printing said image file, wherein said means for writing said description of uses made of said image file comprises means for recording said printing of said image file in said event log.

33. The system of claim 23, further comprising means for renaming, moving or copying said image file, said means for writing said description of uses made of said image file comprises means for recording said renaming, moving or copying of said image file in said event log.

34. The system of claim 23, further comprising:
means for selecting said image file; and
means for reviewing contents of said event log.
